(19) United States
(12) Patent Application Publication
(10) Pub. No.: US 2017/0208049 A1
(43) Pub. Date: Jul. 20, 2017

(54) KEY AGREEMENT METHOD AND DEVICE FOR VERIFICATION INFORMATION

(71) Applicant: Beijing Qihoo Technology Company Limited, Xichebg District (CN)

(72) Inventor: Yuguang Hu, Hai Dian District (CN)

(73) Assignee: Beijing Qihoo Technology Company Limited, xicheng District (CN)

(21) Appl. No.: 15/315,205

(22) PCT Filed: May 29, 2015
(86) PCT No.: PCT/CN2015/080338

§ 371 Date: Nov. 30, 2016

(30) Foreign Application Priority Data
May 30, 2014 (CN) 201410240893.7

(51) Int. Cl. H04L 29/06; H04L 9/32; H04L 29/08

(52) U.S. Cl. CPC H04L 63/061; H04L 67/10; H04L 63/0435; H04L 63/0442; H04L 63/083; H04L 9/3247

(57) ABSTRACT

Disclosed is a key agreement method for verification information. The method comprises: generating a key pair for encrypting and decrypting verification information in a terminal, transmitting a public key to a network device via a network, and storing a private key locally, wherein the verification information is a message used for verifying a terminal or user's identity or permission during execution of a specific service by a target application; the network device uses the public key to encrypt the verification information before the verification information is sent to the terminal, and sends the encrypted verification information to the terminal; the terminal uses the private key to decrypt the encrypted verification information, and obtains the verification information.

### CROSS-REFERENCE TO RELATED APPLICATIONS

This application is a U.S. National-Stage entry under 35 U.S.C. §371 based on International Application No. PCT/CN2015/080338 filed May 29, 2015, and which claims priority to Chinese Application No. 201410240893.7, filed May 30, 2014, which are all incorporated in their entirety by reference.

### TECHNICAL FIELD

This Application pertains to network security, and more specifically to a key agreement method and device for verification information.

### BACKGROUND

In current mobile services, it is usual that a user uses verification information to operate to ensure security of services. The user may obtain verification information in a manner such as short message or e-mail. For example, when a mobile phone is used to register an account or perform payment, a service terminal needs to send a short message to the current mobile phone number for identity verification, and the short message is sent in a plain text manner. However, currently some operation system (e.g., Android) platforms are relatively open, and any software may read the short message content randomly after a permission to access to the short message is registered, which causes extreme hidden risks in respect of security.

During many authentications, particularly for payment, mobile phone short message verification is the last security measure. Usually, a server (a service provider such as Alipay), via a short message gateway, sends a short message including a verification code consisting of digits or characters to a mobile phone number previously bounded by the user. After reception of the short message, the user submits the verification code in the short message to the server via a mobile phone APP or WEB page for authentication or payment. According to the submitted verification code, the server judges whether it is indeed the user who performs verification or payment operation.

The problem lies in that a short message of a mobile phone as a private belonging is not as safe as understood by a service provider and user. When a mobile phone is turned on to view each installed application randomly, it is found that many applications seemingly irrelevant requires a permission to read or even send the short message. It can be seen from this, which the user by no means cares that the installed applications possess some permissions. A malicious Trojan application may completely read the aforesaid verification code without notice. As for systems with versions prior to Android 4.4 (a majority of Android mobile phones in the current market), Trojan even may delete the short message after stealing the short message containing the verification code in the absence of Root, and the verification code is stolen without any notice of a user.

In addition to the case that the malicious Trojan might steal the verification code-containing short message, there is further a serious problem that the mobile phone might be lost. In the case that the mobile phone gets lost, a person obtaining the mobile phone may very easily use a function of retrieving the password through a short message to perform many operations, including modifying user login password, payment and account transfer and the like.

In addition, other objects, desirable features and characteristics will become apparent from the subsequent summary and detailed description, and the appended claims, taken in conjunction with the accompanying drawings and this background.

### SUMMARY

In view of the above problems, the present invention provides a key agreement method and device for verification information, which can solve the above problems or at least partially solve the above problems.

According to an aspect of the present invention, there is provided a key agreement method for verification information, comprising: generating a key pair for encrypting and decrypting the verification information in a terminal, transmitting a public key to a network device via a network, and storing a private key locally, wherein the verification information is a message used for verifying a terminal or a user's identity or permission during execution of a specific service by a target application; encrypting, by the network device, the verification information by using the public key before the verification information is sent to the terminal, and sending the encrypted verification information to the terminal; decrypting, by the terminal, the encrypted verification information by using the private key, and obtaining the verification information.

According to another aspect of the present invention, there is provided a key agreement device for verification information, comprising: a key pair generating unit configured to generate a key pair for encrypting and decrypting the verification information in a terminal, transmit a public key to a network device via a network, and store a private key locally, wherein the verification information is a message used for verifying a terminal or a user's identity or permission during execution of a specific service by a target application; an encrypted verification information receiving unit configured to receive from the network device the encrypted verification information which is encrypted by using the public key; an encrypted verification information decrypting unit configured to use the private key to decrypt the encrypted verification information, and obtain the verification information.

According to a further aspect of the present invention, there is provided a computer program which comprises a computer readable code which causes a terminal to execute the above-mentioned key agreement method for the verification information, when said computer readable code is running on the terminal.

According to a further aspect of the present invention, there is provided a computer readable medium which stores thereon the above-mentioned computer program.

As can be seen from the above embodiments, advantageous effects of the present invention as compared with the prior art are as follows: either an APP or the user itself cannot obtain the user's encrypted short message. Hence, even though the mobile phone gets lost, the user's encrypted short message still cannot be read in the case that the attacker possesses the permission of root and even a capability to perform offline analysis and debugging. Only the user in combination with the APP can read the user's short message. The whole process depends on the private key of a terminal protected by the user password as well as a session key stored in the memory of the APP, so even if Trojan program can deceive the user, by phishing, to input a password for the user to unlock the terminal private key, the short message still cannot be read.

In addition, the present invention has an excellent protection effect against attack means such as GSM (Global System for Mobile Communications) signal eavesdropping and SIM (Subscriber Identity Module) card replication. By virtue of the manner of encrypting the verification information according to the present invention, an attacker launching schemes such as GSM signal eavesdropping and SIM card replication can only obtain a ciphertext but not a plain text, and certainly he cannot continue to launch an attack.

Described above is merely an overview of a technical solution of the present invention. In order to more apparently understand the technical means of the present invention to implement in accordance with the contents of specification, and to more readily understand above and other objectives, features and advantages of the present invention, particular embodiments of the present invention are provided hereinafter.

### BRIEF DESCRIPTION OF THE DRAWINGS

The present invention will hereinafter be described in conjunction with the following drawing figures, wherein like numerals denote like elements, and:

FIG. 1 illustrates a flow chart of a key agreement method for verification information according to a non-limiting embodiment of the present invention;

FIG. 2 illustrates a flow chart of a first embodiment of a key agreement method for verification information according to a non-limiting embodiment of the present invention;

FIG. 3 illustrates a flow chart of a second non-limiting embodiment of a key agreement method for verification information according to an embodiment of the present invention;

FIG. 4 illustrates a flow chart of a third non-limiting embodiment of a key agreement method for verification information according to an embodiment of the present invention;

FIG. 5 illustrates a structural schematic diagram of a key agreement device for verification information according to a non-limiting embodiment of the present invention;

FIG. 6 illustrates a block diagram of a terminal for performing a key agreement method for verification information according to a non-limiting embodiment of the present invention;

FIG. 7 illustrates a non-limiting embodiment of a storage unit for maintaining or carrying a program code for implementing the key agreement method for verification information according to the present invention.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The following will describe in more detail the exemplary embodiments of the present invention with reference to the accompanying drawings. Although the accompanying drawings display the exemplary embodiments of the present invention, it should be understood that the present invention may be implemented in various forms but not limited by the embodiments set forth herein. Instead, these embodiments are provided to more thoroughly understand the present invention, and completely convey the scope of the present invention to those skilled in the art.

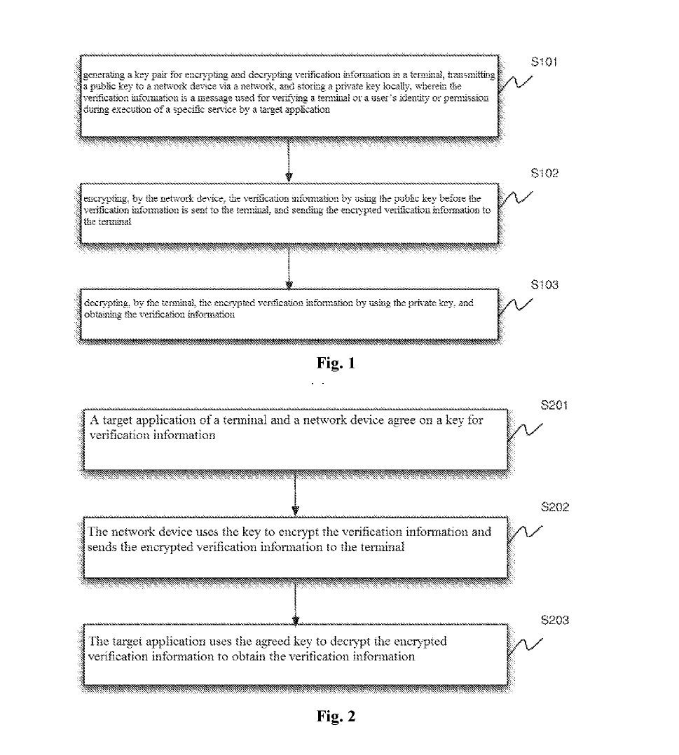

Referring to FIG. 1, FIG. 1 illustrates a flow chart of a key agreement method for verification information according to an embodiment of the present invention, comprising the following steps:

S101: generating a key pair for encrypting and decrypting verification information in a terminal, transmitting a public key to a network device via a network, and storing a private key locally, wherein the verification information is a message used for verifying a terminal or a user's identity or permission during execution of a specific service by a target application;

S102: encrypting, by the network device, the verification information by using the public key before the verification information is sent to the terminal, and sending the encrypted verification information to the terminal;

S103: decrypting, by the terminal, the encrypted verification information by using the private key, and obtaining the verification information.

The verification information may be obtained after the above steps are executed, whereby during execution of a specific service by a target application, the verification information may be used to verify an identity or permission of the terminal, or verify the user's identify or permission. Wherein the target application refers to application which needs to verify the verification information so as to provide services, and includes but is not limited to communication software, payment software or E-commerce software such as the currently-prevailing Alipay and WeChat and the like. Executing a specific service on the target application refers to executing services such as payment, login or download on the target application after the successful passing authentication of the terminal or user's identity or permission by using the verification information. In the solution of the present invention, a key is determined by key agreement between an application and a network device (e.g., a server), and the verification information is encrypted by using the agreed key. Those skilled in the art can understand that keys may be classified into symmetrical keys and asymmetrical keys. The symmetrical keys are also called private key encryption or session key encryption algorithm, i.e., a sender and a receiver of message use the same key to encrypt or decrypt data. Its biggest advantage lies in quick encryption/decryption speed and adaption to encrypt massive data, but key management is difficult. The asymmetrical key encrypting system is also called public key encryption. It needs to use different keys to accomplish encrypting or decrypting operation respectively. One is published or issued as a published key or public key, and the other is secretly stored by the user itself as a privately-used key or private key. A message sender encrypts by using a public key, whereas the message receiver uses the private key for decryption. The public key mechanism is flexible, but the encryption and decryption speed is much slower than the symmetrical key encryption. In the present invention, the asymmetrical key is preferably used. The asymmetrical key algorithm comprises RSA, Elgamal, knapsack algorithm, Rabin, D-H, ECC (elliptic curve cryptosystem) and the like. The frequently-used algorithm is RSA algorithm, and Elgamal is another commonly-used asymmetrical encryption algorithm. The present invention does not limit key algorithm.

It can be seen that via key agreement between the application and the network device, encryption processing is performed on the verification information, and the application directly reads the encrypted verification information to thereby use the decrypted verification information to perform operations such as services, that is, only this application can decrypt the verification information in a ciphertext form. Regarding a malicious application such as Trojan, even though the verification information can be obtained, since the verification information is in the ciphertext form, it cannot be used so that the security of performing service operations such as a payment on the application is effectively ensured.

In addition, the present invention has an excellent protection effect against attack means such as GSM signal eavesdropping and SIM card replication. By virtue of the manner of encrypting the verification information according to the present invention, an attacker launching schemes such as GSM signal eavesdropping and SIM card replication can only obtain a ciphertext but not a plain text, and certainly he cannot continue to launch an attack.

To distinguish from other keys to be introduced below, the key pair agreed in the above steps S101-S104 is called a terminal key pair, and a public key in the terminal key pair is called a terminal public key, and a private key in the terminal key pair is called a terminal private key.

A preferred embodiment is introduced as follows.

In the preferred embodiment, illustration is provided by taking “safe contacts” software installed on the mobile phone as an example. The “safe contacts” is the above-mentioned application and may be understood as a security software responsible for safeguarding mobile phone information security. The network device in the present embodiment refers to a safe contacts server (hereinafter referred to as the server). The private key pair is obtained by employing RSA algorithm and comprises an RSA public key and an RSA private key.

The user installs safe contacts on the mobile phone and built-in a server public key, clicks to set “encrypted-short-message password”, and inputs a password. The safe contacts automatically generate a RSA key pair, meanwhile performs HASH algorithm on the password input by the user, uses the HASH result as a KEY to encrypt the RSA private key, stores the encrypted RSA private key on the mobile phone, and meanwhile uploads the RSA public key to the server via a network.

The safe contacts regularly (e.g., per 24 hours) sends to the safe contacts server a session key encrypted by using a server public key to report its active status. The safe contacts server records the session key with respect to the mobile phone.

Before the server sends a sensitive short message (e.g., verification code short message), the RSA public key and session key corresponding to the user is queried and obtained through the user's mobile phone device information (e.g., an identifier of the device upon delivery out of the factory, mobile phone serial number, IMEI, IMSI).

The server first uses the user's RSA public key to encrypt the short message content, and then uses the session key to encrypt again, and finally uses the server private key to sign the short message, and then sends the encrypted and signed short message.

The user receives an encrypted short message in a special format.

First, the safe contacts application performs signature check on the short message. Then, the safe contacts use the above-mentioned session key (stored in a memory of the mobile phone) to decrypt the short message to unlock the first encryption to obtain the ciphertext encrypted using the user RSA public key. The safe contacts prompt the user to input the encrypted-short-message password. After the user inputs the encrypted-short-message password, the password is used to attempt to decrypt the RSA private key stored in the mobile phone, and finally the RSA private key is used to encrypt the verification information content of the encrypted short message.

In the above preferred embodiment, no one including the safe contacts APP itself is unable to obtain the user's encrypted short message. Hence, even though the mobile phone gets lost, the user's encrypted short message still cannot be read in the case that the attacker possesses the permission of root and even a capability to perform offline analysis and debugging. Only the user in combination of safe contact can read the user's short message. The whole process depends on the RSA private key protected by the user password as well as the session key stored in the memory of the safe contacts, so even if Trojan program deceives the user, by phishing, to input a password for the user to unlock the RSA private key, the short message still cannot be read.

In the present invention, the terminal refers to a terminal having a communication function, such as a smart mobile phone. The network device refers to a server, a gateway or a proxy server for sending verification information for the service of the target application. The target application refers to an application which needs to verify the verification information in order to perform services, and includes but is not limited to communication software, payment software or E-commerce software such as the currently-prevailing Alipay and WeChat and the like. The above steps S101 and S103 may be executed by the target application or by a security application, which will be introduced in detail in subsequent embodiments.

It should be understood that the verification information is information initiated by the target application and used to perform user identity authentication on the target application. Manners for obtaining the verification information are not limited. A common manner at present is obtaining the verification information by a short message, but the present invention does not limit the manners. It is feasible to obtain the verification information by an e-mail, an instant messaging tool or the like.

A condition for implementing the embodiment of the present invention lies in that the application has a permission to access a communication manner to obtain the verification information, for example, the terminal receives the verification information by the short message, and then the application has a permission to access the verification short message, then the application directly accesses the short message and obtains the encrypted verification information using its own permission to access the short message. In this way can step S103 be executed to decrypt the encrypted short message and thereby finally obtain the decrypted verification information.

Embodiments of the present invention will be introduced in detail below with several examples.

### Embodiment 1

Reference is made to FIG. 2 which illustrates a flow chart of a key agreement method for verification information according to a first embodiment of the present invention, comprising:

S201: a target application of the terminal and the network device agree on a key for verification information;

S202: the network device uses the key to encrypt the verification information and sends the encrypted verification information to the terminal;

S203: the target application uses the agreed key to decrypt the encrypted verification information to obtain the verification information.

Wherein, the target application refers to an application which needs to verify the verification information and thereby perform services; it may be appreciated that the network device refers to a server, gateway or proxy server for sending verification information for the service of the target application.

Illustration is provided below for an example of obtaining the verification information by a mobile phone short message.

First, an APP (target APP) installed on the user's mobile phone and the network device agree on a key in a certain manner. The network device refers to a functional entity located on the network side and corresponding to the verification information, and may have many forms. Specifically, the APP may directly agree on a key with the APP server and sends a ciphertext short message, or may agree on a key with the short message gateway and sends the ciphertext short message, or may agree on a key though a proxy server of the short message gateway, which is responsible for agreeing on a key and sending the cyphertext short message. Those skilled in the art appreciate that the short-message service is controlled by an operator, and that if the APP server desires to send the verification short message of the APP service to the terminal, the verification short message is generally sent with the help of a short message service route of the operator. Hence, generally key agreement is performed with the help of the short message gateway or short message gateway proxy server. Certainly, it is also feasible to perform key agreement with the APP server as stated above.

Then, the network device uses the agreed key for encryption upon sending a short message to the user's mobile phone.

Finally, the user receives the encrypted verification short message on the mobile phone, and the APP automatically obtains the short message at the backstage and decrypts it to obtain a true verification code.

For example, the APP in the present embodiment refers to Alipay software. Then, the Alipay software on the mobile phone first needs to agree on a verification code key with the network device (Alipay server, short message gateway or short message gateway proxy server); when the user conducts services such as payment, he needs a verification code, whereupon the network device uses a predetermined key to encrypt the verification code and sends it to the user's mobile phone; finally, the user's mobile phone receives a verification short message in a ciphertext form, the Alipay software on the mobile phone directly reads the ciphertext short message at the backstage, and reads by using the predetermined key, obtains the decrypted verification code, and finally performs verification and accomplish the service.

It can be seen that what the mobile phone receives is the encrypted short message, thereby the verification information cannot be read except the target APP, which effectively solves the problem that the verification short message is stolen by a malicious software such as Trojan.

### Embodiment 2

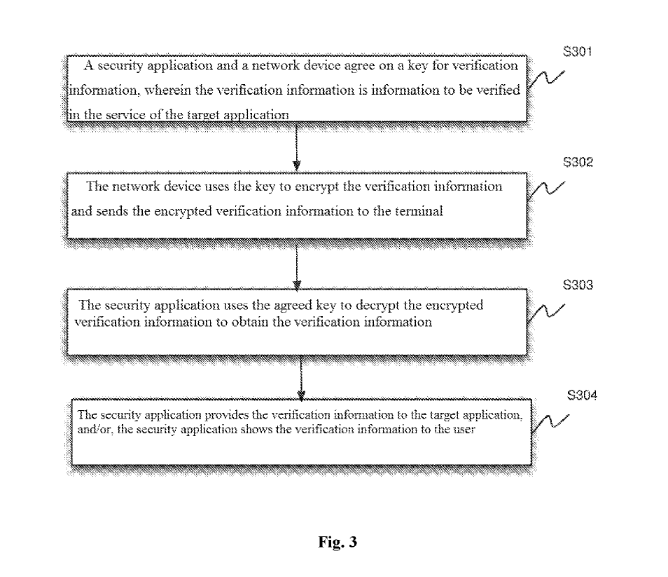

Reference is made to FIG. 3 which illustrates a flow chart of a key agreement method for verification information according to a second embodiment of the present invention, comprising:

S301: a security application and a network device agree on a key for verification information, wherein the verification information is information to be verified in the service of the target application;

S302: the network device uses the key to encrypt the verification information and sends the encrypted verification information to the terminal;

S303: the security application uses the agreed key to decrypt the encrypted verification information to obtain the verification information;

S304: the security application provides the verification information to the target application, and/or, the security application shows the verification information to the user.

Wherein, the target application refers to an application which needs to verify the verification information and thereby perform services; it may be appreciated that the network device refers to a server, a gateway or a proxy server for sending verification information for the service of the target application.

Embodiment 2 differs from embodiment 1 in that a security application is introduced to uniformly manage the verification information for each target application. Specifically, the security application and the network device perform the key agreement, only this security application may read and decrypt the verification information, and the security application provides the decrypted verification information to the target application.

Illustration is provided below for an example of obtaining the verification information by a mobile phone short message.

Different from embodiment 1, a security APP needs to be installed on the user's mobile phone.

First, the security APP and the network device perform key agreement. The network device refers to a functional entity located on a network side and corresponding to the verification information, and may have many forms. Specifically, the security APP may agree on a key with the target APP server and sends a ciphertext short message, or may agree on a key with the short message gateway and sends the ciphertext short message, or may agree on a key though a proxy server of the short message gateway, which is responsible for agreeing on a key and sending the ciphertext short message. Those skilled in the art appreciate that the short-message service is controlled by an operator, and that if the target APP server desires to send the verification short message of the target APP service to the terminal, the verification short message is generally sent with the help of a short message service route of the operator.

Hence, generally, key agreement is performed with the help of the short message gateway or short message gateway proxy server. Certainly, it is also feasible to perform key agreement with the target APP server as stated above.

Then, the network device uses the agreed key for encryption when sending a short message to the user's mobile phone.

Then, the user receives the encrypted verification short message on the mobile phone, and it is decrypted and displayed to the user only by the security APP.

Finally, the target APP obtains the decrypted verification short message via an interface provided by the security APP.

It can be seen that if other APPs need to read a corresponding short message, the short message is no longer obtained through a short message interface of the mobile phone operating system, but obtained via the interface provided by the security APP. The security APP is responsible for verifying legality of the APP attempting to invoke the interface (verifying the signature of the APP, and judging that the short message indeed belongs to the APP. For example, only WeChat App may read a verification code short message sent from the WeChat server), and only when the target APP is legal that the verification information is provided to the target APP.

Wherein the security APP verifying the legality of the target APP comprises: judging whether the target APP is legal according to a signature of the target APP, and/or, judging whether the target APP has a permission to read the verification information. Specifically, judging whether the target APP is legal comprises: judging whether the target APP belongs to a safe APP (white APP list) according to the signature of the target APP, or judging whether the target APP belongs to a malicious APP (black APP list) according to the signature of the target APP. If the target APP belongs to the safe APP or does not belong to the malicious APP, the target APP is determined as legal. It may be appreciated that the white APP and black APP list is pre-obtained and stored on the mobile phone, and the obtaining manner may be setting manually or grasping via the network. Specifically, judging whether the target APP has a permission to read the verification information comprises: judging whether the target APP is an application corresponding to the network device providing the verification information, and, if yes, determining that the target APP has a permission to read the verification information. Specifically, judgment may be performed by judging whether an identifier carried by the verification information corresponds to the network device providing the verification information, for example, via the number that sending the short message.

For example, the target APP in the present embodiment refers to WeChat software, then the security APP (e.g., 360 safe contacts) on the mobile phone first needs to agree on a verification code key with the network device (WeChat server, short message gateway or short message gateway proxy server); when the user conducts services such as payment, he needs a verification code, whereupon the network device uses a predetermined key to encrypt the verification code and sends it to the user's mobile phone; then the user receives a verification short message in a ciphertext form on the mobile phone via a short message, the security APP on the mobile phone directly reads the ciphertext short message at the backstage, and reads by using the predetermined key, obtains the decrypted verification code, and exhibits a plaintext verification code to the user; finally, if necessary, WeChat obtains the plain-text verification code via the interface provided by the security APP.

It can be seen that what the mobile phone receives is the encrypted short message, thereby the verification information cannot be read except the security APP, and the security APP provides the verification short message to the target APP on the basis of verifying the legality of the target APP, which effectively solves the problem that the verification short message is stolen by a malicious software such as Trojan. Furthermore, as compared with embodiment 1, embodiment 2 may exhibit a plaintext verification information to the user, which may satisfy a case in which the verification code is sent by a PC browser, namely, a case in which operation is performed through the target APP on the PC computer.

### Embodiment 3

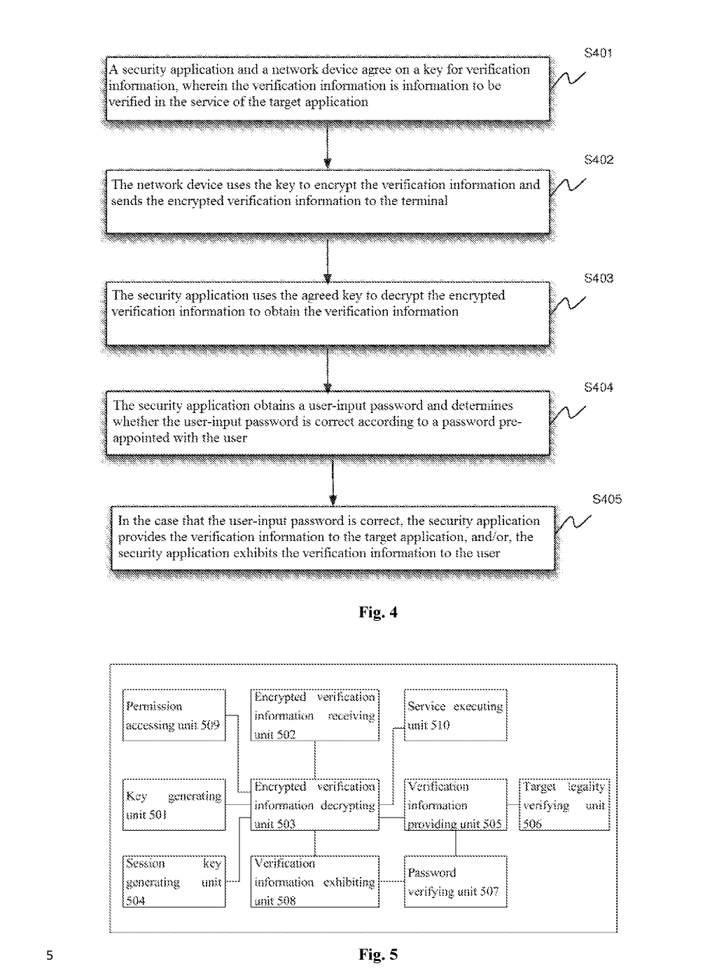

Reference is made to FIG. 4 which illustrates a flow chart of a key agreement method for verification information according to a third embodiment of the present invention, comprising:

S401: a security application and a network device agree on a key for verification information, wherein the verification information is information to be verified in the service of the target application;

S402: the network device uses the key to encrypt the verification information and sends the encrypted verification information to the terminal;

S403: the security application uses the agreed key to decrypt the encrypted verification information to obtain the verification information;

S404: obtaining a user-input password and determining whether the user-input password is correct according to a password pre-appointed with the user;

S405: in the case that the password input by the user is correct, the security application provides the verification information to the target application, and/or, the security application exhibits the verification information to the user.

Wherein, the target application refers to an application which needs to verify the verification information and thereby perform services; then it may be appreciated that the network device refers to a server, a gateway or a proxy server for sending verification information for the service of the target application.

Embodiment 3 is similar to embodiment 2 in that a security application is introduced to uniformly manage the verification information for each target application. Specifically, the security application and the network device perform the key agreement, only this security application may read and decrypt the verification information, and the security application provides the decrypted verification information to the target application. Embodiment 3 differs from embodiment 2 in that prior to exhibiting the verification information to the user or prior to providing the verification information to the target application, the user needs to input a password pre-appointed with the security application.

Illustration is provided below for an example of obtaining the verification information by a mobile phone short message.

A security APP needs to be installed on the user's mobile phone.

First, the security APP and a network device perform key agreement. The network device refers to a functional entity located on a network side and corresponding to the verification information, and may have many forms. Specifically, the security APP may directly agree on a key with the target APP server and sends a ciphertext short message, or may agree on a key with the short message gateway and sends the ciphertext short message, or may agree on a key though a proxy server of the short message gateway, which is responsible for agreeing on a key and sending the ciphertext short message. Those skilled in the art appreciate that the short-message service is controlled by an operator, and that if the target APP server desires to send the verification short message of the target APP service to the terminal, the verification short message is generally sent with the help of a short message service route of the operator. Hence, generally, key agreement is performed with the help of the short message gateway or short message gateway proxy server. Certainly, it is also feasible to perform key agreement with the target APP server as stated above.

Then, the network device uses the agreed key for encryption when sending a short message to the user's mobile phone.

Then, the user receives the encrypted verification short message on the mobile phone, and the security APP decrypts.

Then, when the user needs to view the decrypted verification short message, or the target APP needs to read the verification short message, the user needs to input the password pre-appointed with the security APP.

Finally, the security APP exhibits the decrypted verification short message to the user, or the target APP obtains the decrypted verification short message via an interface provided by the security APP.

It can be seen that if other APPs need to read a corresponding short message, the short message is no longer obtained through a short message interface of the mobile phone operating system, but obtained via the interface provided by the security APP. The security APP is responsible for verifying legality of the APP attempting to invoke the interface (verifying the signature of the APP, and judging that the short message indeed belongs to the APP. For example, only WeChat APP may read a verification code short message sent from the WeChat server), and only when the target APP is legal is that the verification information is provided to the target APP.

Wherein the security APP verifying the legality of the target APP comprises: judging whether the target APP is legal through a signature of the target APP, and/or, judging whether the target APP has a permission to read the verification information. Specifically, judging whether the target APP is legal comprises: judging whether the target APP belongs to a safe APP (white APP list) according to the signature of the target APP, or judging whether the target APP belongs to a malicious APP (black APP list) according to the signature of the target APP. If the target APP belongs to the safe APP or does not belong to the malicious APP, the target APP is determined as legal. It may be appreciated that the white APP and black APP lists are pre-obtained and stored on the mobile phone, and the obtaining manner may be setting manually or grasping via the network. Specifically, judging whether the target APP has a permission to read the verification information comprises: judging whether the target APP is an application corresponding to the network device providing the verification information, and, if yes, determining that the target APP has a permission to read the verification information. Specifically, judgment may be performed by judging whether an identifier carried by the verification information corresponds to the network device providing the verification information, for example, via the number that sending the short message.

For example, the target APP in the present embodiment refers to a bank payment platform to which Amazon is linked, then the security APP (e.g., 360 safe contacts) on the mobile phone first needs to agree on a verification code key with the network device (a bank payment platform server, short message gateway or short message gateway proxy server); when the user conducts services such as payment, he needs a verification code, whereupon the network device uses a pre-appointed key to encrypt the verification code and sends it to the user's mobile phone; then the user receives a verification short message in a ciphertext form on the mobile phone via a short message, and the security APP on the mobile phone directly reads the ciphertext short message at the backstage, and reads by using the pre-appointed key, and obtains the decrypted verification code; after the user inputs a correct password, a plain-text verification code is exhibited to the user; finally, if necessary, the bank payment platform obtains the plain-text verification code via the interface provided by the security APP.

It can be seen that what the mobile phone receives is the encrypted short message, thereby the verification information cannot be read except the security APP, and the security APP provides the verification short message to the APP on the basis of verifying the legality of the target APP, which effectively solves the problem that the verification short message is stolen by a malicious software such as Trojan. Furthermore, as similar to embodiment 2, embodiment 3 may exhibit a plaintext verification information to the user, which may satisfy a case in which the verification code is sent by a PC browser, namely, a case in which operation is performed through the target APP on the PC computer. In addition, as compared with embodiment 2, in embodiment 3, only after the user inputs a correct password, the verification information is exhibited to the user or provided to the target APP, that is, this further ensures security of the verification information. Due to dual protection from the ciphertext verification information and the user password, even if the mobile phone gets lost, security of the verification information can be ensured.

Corresponding to the above method, the present invention further provides a key agreement device for verification information. The device may be implemented by hardware, software or a combination of hardware and software. The device may refer to a function module in a terminal, or refer to the terminal itself, so long as the terminal comprises a function of implementing the device. Referring to FIG. 5, the device comprises:

a key pair generating unit 501 configured to generate a key pair for encrypting and decrypting the verification information in a terminal, transmit a terminal public key to a network device via a network, and store a terminal private key locally, wherein the verification information is a message used for verifying a terminal or a user's identity or permission during execution of a specific service by a target application;

an encrypted verification information receiving unit 502 configured to receive from the network device the encrypted verification information which is encrypted by using the terminal public key;

an encrypted verification information decrypting unit 503 configured to use the private key to decrypt the encrypted verification information, and obtain the verification information.

Preferably, the encrypted verification information is processed by signing using the network device private key; the encrypted verification information decrypting unit 503 is further configured to, prior to using the terminal private key to decrypt, use a pre-obtained network device public key to verify the signature of the encrypted verification information.

Preferably, the device further comprises a session key generating unit 504 configured to generate a session key encrypted by using the network device public key and provide the session key to the network device; after using the terminal public key to encrypt the verification information, the network device further uses the session key to perform secondary encryption on the verification information; in this case, the encrypted verification information decrypting unit 503 is further configured to, prior to using the terminal private key to decrypt the encrypted verification information, use the session key stored locally in the terminal to perform secondary decryption.

Preferably, the terminal private key stored locally by the key pair generating unit 501 is subject to encryption processing using the password input by the user; the encrypted verification information decrypting unit 503, prior to using the terminal private key to decrypt the encrypted verification information, firstly uses the user-input password to decrypt the encrypted terminal private key to obtain the terminal private key.

Preferably, prior to sending the verification information, the network device, through the device information of the terminal, queries and obtains the terminal public key and/or session key corresponding to the user. Wherein, the device information of the terminal comprises a device serial number, mobile phone number, IMEI, and/or IMSI.

Preferably, in a solution, the target application performs the functions of the key pair generating unit 501 and the encrypted verification information decrypting unit 503, namely, it is the target application on the terminal that performs generation of the key pair for encrypting and decrypting the verification information and uses the private key to decrypt the encrypted verification information.

Preferably, in another solution, a newly-added security application performs the functions of the key pair generating unit 501 and the encrypted verification information decrypting unit 503, namely, it is the security application on the terminal that performs generation of the key pair for encrypting and decrypting the verification information and uses the private key to decrypt the encrypted verification information; the device further comprises: a verification information providing unit 505 configured to use the security application to provide the verification information to the target application, wherein the target application refers to application which needs to verify the verification information so as to provide services.

Wherein the target application invokes an interface provided by the security application to obtain the verification information from the security application.

Optionally, the device further comprises: a target legality verifying unit 506 configured to use the security application to verify the legality of the target application; in this case, the verification information providing unit 505 provides the verification information to the target application only when the target application is legal.

Wherein the target legality verifying unit 506 is specifically configured to judge whether the target application is legal according to a signature of the target application, and/or, judge whether the target application has a permission to read the verification information.

Specifically, the target legality verifying unit 506 is specifically configured to: judge whether the target application belongs to a safe application according to the signature of the target application, or judge whether the target application belongs to a malicious application according to the signature of the target application, and determine the target application as legal if the target application belongs to the safe application or does not belong to the malicious application.

Specifically, the target legality verifying unit 506 is specifically configured to judge whether the target application is an application corresponding to the network device providing the verification information, and, if yes, determine that the target application has a permission to read the verification information.

Specifically, the target legality verifying unit 506 is specifically configured to judge whether an identifier carried by the verification information corresponds to the network device providing the verification information.

Preferably, in another solution, the device further comprises: a password verifying unit 507 configured to obtain a user-input password and determine whether the user-input password is correct according to the password pre-appointed with the user; the verification information providing unit 505 provides the verification information to the target application only when the user-input password is correct.

Wherein, the password pre-appointed with the user is a password appointed between the security application and the user.

Preferably, in another solution, the application refers to the security application; the device further comprises a verification information exhibiting unit 508 configured to use the security application to exhibit the decrypted verification information to the user.

Optionally, the device further comprises: a password verifying unit 507 configured to obtain a user-input password and determine whether the user-input password is correct according to the password pre-appointed with the user; the verification information exhibiting unit 508 is configured to exhibit the verification information to the user only when the user-input password is correct.

Wherein the password pre-appointed with the user is a password appointed between the security application and the user.

Wherein the target application comprises an instant messaging software, a payment software or an E-commerce software.

Wherein the network device refers to a server, a gateway or a proxy server for sending verification information.

Wherein the network device learns that the terminal supports the ciphertext verification information through an agreed parameter which is pre-obtained and related to the terminal verification information.

Wherein the key refers to a symmetrical key, and the network device and the application use the same key to encrypt and decrypt the verification information; or the key refers to an asymmetrical key, and the network device uses a public key to encrypt the verification information, and the application uses a private key to decrypt the encrypted verification information.

Wherein the terminal obtains the encrypted verification information from the network device in a communication manner such as short message, e-mail or an instant messaging tool.

Preferably, the device further comprises: a permission accessing unit 509 configured to support the target application or security application to directly access the communication manner to obtain the encrypted verification information by using its own permission to access the communication manner.

Preferably, the device further comprises: a service executing unit 510 configured to use the verification information to verify the terminal or the user's identity or permission during execution of a specific service by the target application.

It should be noted that:

Algorithm and display provided herein are not inherently related to any particular computer, virtual system or other equipment. Various general systems may also be used with the teaching based on the disclosure. According to the above description, the required structure for constructing such a system is obvious. In addition, the present invention is not directed to any particular programming language. It should be understood that a variety of programming languages can be used to implement the disclosed contents of the present invention as described herein and above description to the particular programming language is to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the present invention may sometimes be grouped together into a single embodiment, accompanying figure or description thereof. However, the method of this disclosure should not be constructed as follows: the present invention for which the protection is sought specifies more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Embodiments regarding parts in the present invention may be implemented in hardware, or implemented by software modules running on one or more processors, or implemented by the combination thereof. A person skilled in the art should understand that, in practice, a microprocessor or a digital signal processor (DSP) may be used to realize some or all of the functions of some or all of the modules in the device according to the embodiments of the present invention. The present invention may further be implemented as device program (for example, computer program and computer program product) for executing some or all of the methods as described herein. Such program for implementing the present invention may be stored in the computer readable medium, or have a form of one or more signals. Such a signal may be downloaded from the internet websites, or be provided in carrier, or be provided in other manners.

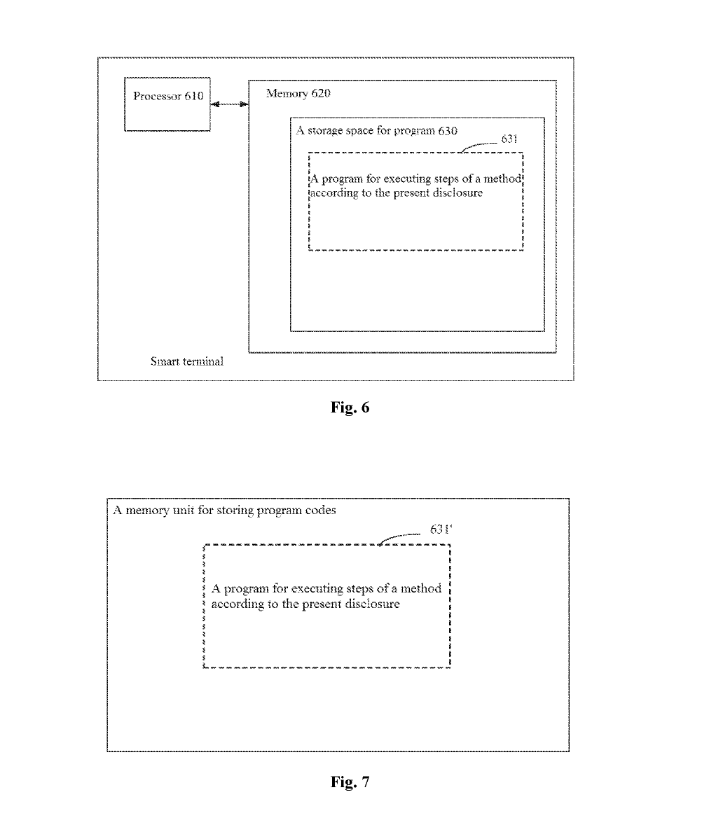

For example, FIG. 6 illustrates a block diagram of a terminal, for example, a smart terminal, for performing a key agreement method for verification information according to the present invention. The terminal conventionally comprises a processor 610 and a computer program product or computer-readable medium in the form of a memory 620. The memory 620 may be a flash memory, EEPROM (Electrically Erasable Programmable Read-Only Memory), EPROM, hard disk or ROM-like electronic memory. The memory 620 has a storage space 630 for a program code 631 for executing any step of the above method. For example, the storage space 630 for the program code may comprise program codes 631 for respectively implementing steps of the above method. These program codes may be read from one or more computer program products or written into the one or more computer program products. These computer program products comprise program code carriers such as hard disk, compact disk (CD), memory card, floppy disk or the like. Such computer program products are usually portable or fixed memory units as shown in FIG. 7. The memory unit may have a storage section, a storage space or the like arranged in a similar way to the memory 620 in the terminal of FIG. 6. The program code may for example be compressed in a suitable form. Usually, the memory unit includes a computer-readable code 631″, namely, a code could be read by a processor such as 610. When these codes are run by the terminal, the terminal is caused to execute steps of the method described above.

It should be noted that the above-described embodiments are intended to illustrate but not to limit the present invention, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A key agreement method for verification information, comprising:
generating a key pair for encrypting and decrypting the verification information in a terminal, transmitting a public key to a network device via a network, and storing a private key locally, wherein the verification information is a message used for verifying a terminal or a user's identity or permission during execution of a specific service by a target application;
encrypting, by the network device, the verification information by using the public key before the verification information is sent to the terminal, and sending the encrypted verification information to the terminal;
decrypting, by the terminal, the encrypted verification information by using the private key, and obtaining the verification information.

2. The method according to claim 1, wherein, after encrypting, by the network device, the verification information by using the public key, signing the encrypted verification information by using a network device private key;
prior to decrypting, by the terminal, the encrypted verification information by using the private key, firstly checking the signature of the encrypted verification information by using a pre-obtained network device public key.

3. The method according to claim 2, further comprises:
regularly sending, by the terminal, to the network device a session key encrypted by the network device public key;
after encrypting, by the network device, the verification information by using the public key, performing secondary encryption upon the verification information by using the session key;
prior to decrypting the encrypted verification information by using the private key, performing secondary decryption upon the encrypted verification information by using the session key stored locally in the terminal.

4. The method according to claim 3, wherein providing the user with a password input interface, receiving a user-input password, and using the user-input password to encrypt the private key;
before decrypting the encrypted verification information by using the private key, requiring the user to input the password, and if the user-input password is correct, using the user-input password to decrypt the encrypted private key to obtain the private key and performing the step of decrypting the encrypted verification information by using the private key.

5. (canceled)

6. (canceled)

7. (canceled)

8. The method according to claim 1, wherein a security application on the terminal performs the step of generating the key pair for encrypting and decrypting the verification information and decrypting the encrypted verification information by using the private key;
after obtaining the verification information, the method further comprises:
providing, by the security application, the verification information to the target application or exhibiting the verification information to the user.

9. (canceled)

10. The method according to claim 8, wherein further comprises:
verifying, by the security application, the legality of the target application; and providing the verification information to the target application only when the target application is legal.

11. The method according to claim 10, wherein verifying, by the security application, the legality of the target application comprises:
judging whether the target application is legal according to a signature of the target application, and/or, judging whether the target application has a permission to read the verification information.

12. The method according to claim 11, wherein the judging whether the target application is legal comprises:
judging whether the target application belongs to a safe application according to the signature of the target application, or judging whether the target application belongs to a malicious application according to the signature of the target application, and determining the target application legal if the target application belongs to the safe application or does not belong to a malicious application.

13. The method according to claim 11, wherein the judging whether the target application has a permission to read the verification information comprises:
judging whether the target application is an application corresponding to the network device providing the verification information, and, if yes, determining that the target application has a permission to read the verification information.

14. (canceled)

15. (canceled)

16. (canceled)

17. (canceled)

18. (canceled)

19. (canceled)

20. A key agreement device for verification information, comprising a memory having instructions stored thereon and at least one processor to execute the instructions to perform operations for key agreement for verification information, the operations comprising:
generating a key pair for encrypting and decrypting the verification information in a terminal, transmitting a public key to a network device via a network, and storing a private key locally, wherein the verification information is a message used for verifying a terminal or a user's identity or permission during execution of a specific service by a target application;
receiving from the network device the encrypted verification information which is encrypted by using the public key;
decrypting the encrypted verification information by using the private key, and obtaining the verification information.

21. The device according to claim 20, wherein the encrypted verification information is processed by signing using a network device private key;
the decrypting the encrypted verification information by using the private key, and obtaining the verification information comprises:
prior to using the private key to decrypt, using a pre-obtained network device public key to verify the signature of the encrypted verification information.

22. The device according to claim 21, wherein the operations further comprises:
generating a session key encrypted by using the network device public key and providing the session key to the network device;
after using the public key to encrypt the verification information, using, by the network device, the session key to perform secondary encryption for the verification information;
the decrypting the encrypted verification information by using the private key, and obtaining the verification information comprises:
prior to using the private key to decrypt the encrypted verification information, using the session key stored locally in the terminal to perform secondary decryption.

23. The device according to claim 22, wherein
the private key stored locally is subject to encryption processing using a password input by the user;
the decrypting the encrypted verification information by using the private key, and obtaining the verification information comprises:
prior to using the private key to decrypt the encrypted verification information, firstly using the user-input password to decrypt the encrypted private key to obtain the private key.

24. (canceled)

25. (canceled)

26. (canceled)

27. The device according to claim 20 25, wherein a security application on the terminal performs generation of the key pair for encrypting and decrypting the verification information and use of the private key to decrypt the encrypted verification information;
the operations further comprises:
using the security application to provide the verification information to the target application; or
using the security application to exhibit the decrypted verification information to the user.

28. (canceled)

29. The device according to claim 27, wherein the operations further comprises:
using the security application to verify the legality of the target application;
the using the security application to provide the verification information to the target application comprises:
providing the verification information to the target application only when the target application is legal.

30. The device according to claim 29, wherein the using the security application to verify the legality of the target application comprises:
judging whether the target application is legal by a signature of the target application, and/or, judging whether the target application has a permission to read the verification information.

31. The device according to claim 30, wherein the using the security application to verify the legality of the target application comprises:
judging whether the target application belongs to a safe application according to the signature of the target application, or judging whether the target application belongs to a malicious application according to the signature of the target application, and determining the target application as legal if the target application belongs to the safe application or does not belong to the malicious application.

32. The device according to claim 30, wherein the using the security application to verify the legality of the target application comprises:
judging whether the target application is an application corresponding to the network device providing the verification information, and, if yes, determining that the target application has a permission to read the verification information.

33. (canceled)

34. (canceled)

35. (canceled)

36. (canceled)

37. (canceled)

38. (canceled)

39. (canceled)

40. A computer-readable medium, having instructions stored thereon, when executed by at least one processor, cause the at least one processor to perform operations for key agreement for verification information, the operations comprising:
generating a key pair for encrypting and decrypting the verification information in a terminal, transmitting a public key to a network device via a network, and storing a private key locally, wherein the verification information is a message used for verifying a terminal or a user's identity or permission during execution of a specific service by a target application;
encrypting, by the network device, the verification information by using the public key before the verification information is sent to the terminal, and sending the encrypted verification information to the terminal; and
decrypting, by the terminal, the encrypted verification information by using the private key, and obtaining the verification information.
